(19) United States
(12) Patent Application Publication
(10) Pub. No.: US 2010/0306135 A1
(43) Pub. Date: Dec. 2, 2010

(54) METHOD OF IMPROVING MEDICAL DIAGNOSES REPORTING AS DIAGNOSIS-RELATED GROUPS

(76) Inventors: Jack Edward McCallum, Fort Worth, TX (US); William Jay McCallum, Fort Worth, TX (US)

Correspondence Address: HITCHCOCK EVERT LLP, P.O. BOX 131709, DALLAS, TX, 75313-1709, US

(21) Appl. No.: 12/473,426

(22) Filed: May 28, 2009

(51) Int. Cl. G06Q 90/00

(52) U.S. Cl. 705/500

(57) ABSTRACT

The present invention relates generally to healthcare, and more specifically to a process for more completely and more accurately reporting a patient diagnosis under the Diagnosis-Related Group (“DRG”) system promulgated by the United States Centers for Medicare and Medicaid Services (“CMS”). In particular, the invention relates to a method for reviewing hospital discharge charts; identifying diagnosis codes which may be inaccurate or inadequately documented; gathering a set of clinical guidelines related to the medical conditions represented by such inaccurately or inadequately documented diagnosis codes; and presenting the identified codes with the gathered clinical guidelines to a treating healthcare provider for the provider's review and possible alteration.

### FIELD OF THE INVENTION

The present invention relates generally to healthcare, and more specifically to a process for more completely and more accurately reporting a patient diagnosis under the Diagnosis-Related Group (“DRG”) system promulgated by the United States Centers for Medicare and Medicaid Services (“CMS”). In particular, the invention relates to a method for reviewing hospital discharge charts; identifying diagnosis codes which may be inaccurate or inadequately documented; gathering a set of clinical guidelines related to the medical conditions represented by such inaccurately or inadequately documented diagnosis codes; and presenting the identified codes with the gathered clinical guidelines to a treating healthcare provider for the provider's review and possible alteration of the identified codes.

The present invention further relates to the field of improving patient healthcare, as by more accurately recording patient diagnoses, the hospital in connection with which the present method is applied may more completely recoup reimbursement from CMS for providing patient treatment. In so doing, the hospital, when properly compensated, may be able to improve patient care by improving capital equipment, hiring additional care givers, etc.

In addition, the present invention relates to a method for processing data presented in a hospital discharge chart to determine if any potentially inaccurate or inadequate discharge codes are contained therein and to identify such codes. In this aspect, the present invention further relates to a method for associating a set of related clinical guidelines with any identified codes and thereafter presenting the identified codes in connection with the related clinical guidelines to a healthcare provider for further analysis.

### BACKGROUND OF THE INVENTION

The following background of the present invention will discuss generally the DRG system and how that system is used by CMS and by hospitals. However, it should be understood that the discussion of the DRG system and CMS is by way of example only, and that the method of the present invention may be practiced in association with other diagnosis reporting systems.

In the United States, CMS reimburses hospitals for treating patients who are covered by CMS' Medicare program. In order to simplify payments, CMS utilizes the DRG system to group patient treatments into a diagnostic group. In other words, CMS will reimburse a hospital a predetermined amount per patient based on that group. The DRG system assigns a single diagnosis group to each patient based on the patient's diagnosis codes and procedures. The hospital is reimbursed the same amount for every Medicare patient treated with the same diagnosis group. While payments under the DRG system do vary regionally, and with variations in patient age, sex and other characteristics, the DRG system simplifies the payment system and provides prospectively determined payments to hospitals treating Medicare patients. With that said, the DRG system creates instances in which, through inaccurate or incomplete diagnosis coding, a hospital could fail to receive appropriate reimbursement from CMS.

Under the DRG system, a hospital identifies a primary diagnosis or surgical procedure for each Medicare patient it treats. Simultaneously, the hospital may also identify a secondary diagnosis known as a Complication and/or Comorbidity (“CC”) accompanying the DRG. Examples of CCs include substance dependence/abuse, chronic pulmonary disease, and congestive heart failure. In certain circumstances, the DRG may be accompanied by a more serious Major Complication and/or Comorbidity (“MCC”), signifying a significant secondary complication to the primary DRG. Examples of MCCs include cardiac arrest, diabetes, and acute respiratory failure. The presence of a CC or MCC will significantly increase the payment made by CMS to the treating hospital, as the presence of the conditions represented by the CC or MCC generally significantly increases the cost of treatment for the hospital.

Currently most hospitals employ a system wherein a healthcare provider (usually a physician) dictates or otherwise records a set of notes regarding a patient. These notes are typically passed to a hospital's coding department where diagnoses and procedures documented in them are converted to DRGs and, if applicable, CCs and MCCs. The completed set of codes is contained in a discharge abstract which is then used as a part of the process for reimbursement from CMS.

This system, however, generally does not provide a step for review and analysis of the completeness and specificity of notes provided by the physician. Individual coders are limited in what they can code by the documentation provided by the physician. Incomplete or inaccurate documentation may lead to incorrect coding and opportunities may be lost for including legitimate CCs and MCCs which would negatively impact payment to the hospital. As the inclusion of an MCC can, in some circumstances, triple or quadruple the amount due to a hospital, the failure to submit an accurate MCC because of incompletely or inaccurately coded hospital discharge charts could lead to significant losses.

The method of the present invention addresses this lost opportunity by providing a check of hospital discharge charts to identify instances in which there is a high likelihood that the coded information is inaccurate, incomplete, or both. Once such an instance has been identified, the present method assists the hospital in correcting the coded information by both identifying related DRG, CC, and/or MCC codes which may be more accurate and/or more complete, while also reproducing clinical guidelines relevant to the identified codes for the healthcare provider's review. Specifically, after identifying a suspect code and presenting relevant clinical guidelines, in some embodiments in a question and answer format, the method of the present invention allows the healthcare provider to reconsider the discharge notes previously recorded, and to consider additional documentation and a revised set of discharge notes that more fully and accurately document all relevant patient diagnoses.

### SUMMARY OF THE INVENTION

It is an object of the present invention to improve the accuracy and completeness of coding of DRGs.

It is a further object of the present invention to improve the accuracy of hospitals' reporting of CCs and MCCs in their discharge charts.

It is a further object of the present invention to provide relevant clinical guidelines for healthcare providers to use in documenting episodes of hospital care.

It is a further object of the present invention to provide a method whereby each patient discharge chart can be reviewed and analyzed for complete and accurate coding prior to submission of a patient bill to CMS.

It is a further object of the present invention to improve the quality of patient care at hospitals that receive compensation from CMS for treatment of Medicare patients by improving the likelihood that the hospital will be correctly reimbursed for treating patients with certain complications.

It is a further object of the present invention to generate and process discharge chart data in a manner which will improve accuracy in future submissions to insurance payors such as CMS.

### BRIEF DESCRIPTION OF THE DRAWINGS

FIG. 1 is a flowchart depicting the steps of the present invention.

### DETAILED DESCRIPTION

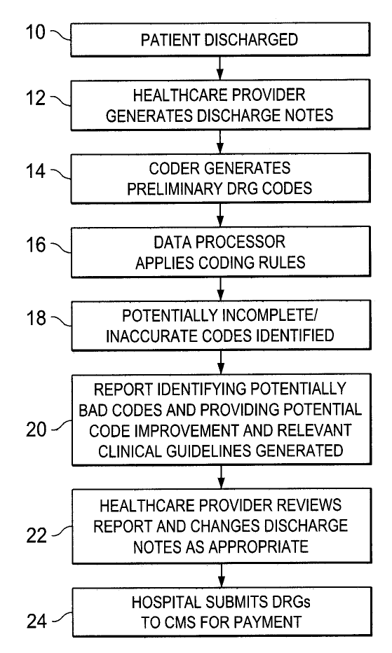

With reference to FIG. 1, the method of the present invention is a multi-step process beginning with the step 10 of patient discharge from a hospital employing the present method. Contemporaneously with patient discharge, in step 20, the patient's healthcare provider generates a set of discharge notes recording the patient diagnoses, treatments performed, and any other information germane to the patient's hospital interaction. In step 14, the healthcare provider's set of discharge notes are reviewed by a medical coder who prepares an initial DRG report based on the notes.

In step 16, the initial DRG report is provided to a data processor which then applies a set of rules to the initial DRG report so that in step 18 the data processor may identify potentially incomplete or inaccurate DRGs. In particular, the data processor may identify sections of physician notes or initial DRG codes that appear to support a particular DRG, but which may not be written in a way to fully communicate a particular diagnosis. For example, the notes provided by a healthcare provider may indicate a general diagnosis such as “non-specific hypertension.” While such a diagnosis will support a DRG, it may not fully express the nature of the patient's medical condition, and furthermore, may not support a classification as a CC or MCC. However, the analysis rules employed by the data processor may suggest an alternate, more complete diagnosis such as “hypertension due to renal failure due to diabetes.”

Of course, the data processor is not qualified to make an actual diagnosis. Therefore, in the method of the present invention, in step 20, a report is prepared for review by the patient's healthcare provider that includes not only an identification of a potentially incomplete or inaccurate code, but also the relevant clinical guidelines designed to assist the healthcare provider in determining if there is an alternate, more complete diagnosis which is accurate and more fully captures the actual patient condition. While preparing a report with such information is the preferred method of reporting, one having skill in the art will recognize that other methods of reporting the information may be implemented and remain within the scope and spirit of the invention. In a preferred embodiment of the present invention, the report prepared in step 20 is returned to the treating hospital by the next day. In a more preferred embodiment, the report prepared in step 20 is returned to the treating hospital within four (4) hours of delivery to the data processor.

In step 22, the healthcare provider reviews the report prepared in step 20, including the clinical guidelines associated with the suggested alternate diagnosis. The provider may revise or amend his or her earlier discharge notes to reflect the alternate diagnosis. Alternatively, if the healthcare provider does not agree that the guidelines for such alternate diagnosis have been met, he or she may simply ignore the suggestion, or note why the suggestion was incorrect. In one embodiment of the present invention, the clinical guidelines are presented to the healthcare provider in question and answer format. Such a format may simplify the review process for the healthcare provider, and is especially well suited for situations where the relevant clinical guidelines contain a checklist that the healthcare provider can note in their revised patient notes as necessary.

In step 24, the hospital submits the DRG report, revised as appropriate, to CMS for reimbursement.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

1. A method for improving medical diagnoses reporting as Diagnosis-Related Groups comprising the steps of:
a) Applying coding rules to a preliminary set of previously prepared Diagnosis-Related Group codes;
b) Identifying potentially incomplete codes within said preliminary set of Diagnosis-Related Group codes; and
c) Reporting said potentially incomplete codes that are identified.

2. The method of claim 1 further comprising the step of identifying additional codes that relate to said identified incomplete codes.

3. The method of claim 2 further comprising the step of reporting said additional codes.

4. The method of claim 2 further comprising the step of identifying clinical guidelines that relate to said additional codes.

5. The method of claim 4 further comprising the steps of:
a) Reporting said additional codes; and
b) Reporting said clinical guidelines.

6. The method of claim 1 further comprising the step of identifying potentially inaccurate codes within said preliminary set of previously prepared Diagnosis-Related Group codes.

7. The method of claim 6 further comprising the step of reporting said inaccurate codes.

8. The method of claim 7 further comprising the steps of:
a) Identifying a first set of additional codes that relate to said incomplete codes; and
b) Identifying a second set of additional codes that relate to said inaccurate codes.

9. The method of claim 8 further comprising the steps of:
a) Reporting said first set of additional codes; and
b) Reporting said second set of additional codes.

10. The method of claim 8 further comprising the steps of:
a) Identifying clinical guidelines that relate to said first set of additional codes; and
b) Identifying clinical guidelines that relate to said second set of additional codes.

11. The method of claim 10 further comprising the steps of:
a) Reporting said first set of additional codes;
b) Reporting said second set of additional codes;
c) Reporting said clinical guidelines that relate to said first set of additional codes; and
d) Reporting said clinical guidelines that relate to said second set of additional codes.

12. A method for improving medical diagnoses reporting as Diagnosis-Related Groups comprising the steps of:
a) Applying coding rules to a preliminary set of previously prepared Diagnosis-Related Group codes;
b) Identifying potentially inaccurate codes within said preliminary set of Diagnosis-Related Group codes; and
c) Reporting said potentially inaccurate codes that are identified.

13. The method of claim 12 further comprising the step of identifying additional codes that relate to said identified inaccurate codes.

14. The method of claim 13 further comprising the step of reporting said additional codes.

15. The method of claim 13 further comprising the step of identifying clinical guidelines that relate to said additional codes.

16. The method of claim 15 further comprising the steps of:
a) Reporting said additional codes; and
b) Reporting said clinical guidelines.

17. The method of claim 12 further comprising the step of identifying potentially incomplete codes within said preliminary set of previously prepared Diagnosis-Related Group codes.

18. The method of claim 17 further comprising the step of reporting said incomplete codes.

19. The method of claim 18 further comprising the steps of:
a) Identifying a first set of additional codes that relate to said inaccurate codes; and
b) Identifying a second set of additional codes that relate to said incomplete codes.

20. The method of claim 19 further comprising the steps of:
a) Reporting said first set of additional codes; and
b) Reporting said second set of additional codes.

21. The method of claim 19 further comprising the steps of:
a) Identifying clinical guidelines that relate to said first set of additional codes; and
b) Identifying clinical guidelines that relate to said second set of additional codes.

22. The method of claim 21 further comprising the steps of:
a) Reporting said first set of additional codes;
b) Reporting said second set of additional codes;
c) Reporting said clinical guidelines that relate to said first set of additional codes; and
d) Reporting said clinical guidelines that relate to said second set of additional codes.
